(19) United States
(12) Patent Application Publication
(10) Pub. No.: US 2026/0162360 A1
(43) Pub. Date: Jun. 11, 2026

(54) TECHNIQUES FOR EMERGENT SCENE DECOMPOSITION FROM MULTI-TRAVERSE

(71) Applicant: NVIDIA CORPORATION, Santa Clara, CA (US)

(72) Inventors: Yiming LI, Jersey City, NJ (US); Yue WANG, Los Angeles, CA (US); Zhiding YU, Santa Clara, CA (US); Zan GOJCIC, Zurich (CH); Marco PAVONE, Stanford, CA (US); Jose Manuel ALVAREZ LOPEZ, Mountain View, CA (US)

(21) Appl. No.: 19/182,387

(22) Filed: Apr. 17, 2025

Related U.S. Application Data
(60) Provisional application No. 63/647,298, filed on May 14, 2024.

(51) Int. Cl. G06T 15/20; G06T 7/70

(52) U.S. Cl. CPC G06T 15/205; G06T 7/70

(57) ABSTRACT

Techniques for emergent scene decomposition from multi-traverse include receiving a plurality of images from multiple traversals of a scene; generating a plurality of 3D Gaussians from the plurality of images; projecting each of the plurality of 3D Gaussians to generate a plurality of rendered 2D images; extracting a feature map from each of the plurality of images and the plurality of rendered 2D images; generating ephemeral objects masks for the plurality of images from the feature maps and the plurality of rendered 2D images; generating optimized 3D Gaussians from the plurality of images, the plurality of rendered 2D images, and the ephemeral objects masks; and generating a 3D environment from the optimized 3D Gaussians.

### CROSS-REFERENCE TO RELATED APPLICATIONS

This application claims priority benefit of the United States Provisional Patent Application titled, “TECHNIQUES FOR EMERGENT SCENE DECOMPOSITION FROM MULTI-TRAVERSE,” filed on May 14, 2024, and having Ser. No. 63/647,298. The subject matter of this related application is hereby incorporated herein by reference.

### BACKGROUND OF THE INVENTION

### Field of the Invention

Embodiments of the present disclosure relate generally to autonomous vehicle technology, three-dimensional mapping and environmental modeling, and artificial intelligence and, more specifically, to techniques for emergent scene decomposition from multi-traverse.

### Description of the Related Art

Autonomous vehicles are vehicles capable of operating with little or no human intervention. Ideally, autonomous vehicles should be responsible for all driving actions of the vehicle, including navigating and operating important vehicle systems. Accordingly, an autonomous vehicle should be equipped with an accurate three-dimensional (3D) map in order to navigate and respond to the surrounding environment as precisely and accurately as possible.

Structure-from-motion (SfM) is a technique commonly used for 3D map reconstruction. In SfM, a sequence of two-dimensional (2D) images taken from different viewpoints is used to estimate the 3D structure of a given 3D scene. For each 2D image, SfM estimates the position and orientation of the camera used to generate the 2D image. However, each camera pose estimation usually contains various errors, and these errors accumulate as the number of viewpoints increases, resulting in bent or distorted 3D scene reconstructions. Thus, reconstructing 3D structures of 3D scenes that are accurate in terms of both depth and geometric information from 2D images can be quite difficult. In addition, distinguishing ephemeral objects, which are objects that either appear or disappear over time across different 2D images of the same general location (e.g., pedestrians, motorbikes, and vehicles), from permanent objects is important because the presence of ephemeral objects in the 2D images can disrupt the consistency of 3D map reconstruction, resulting in a reconstructed 3D map that inaccurately conveys the 3D scene.

One approach for improving the accuracy of 3D scene reconstruction is to employ a neural network that is trained to segment ephemeral objects from 2D images. One drawback of this approach, however, is that neural networks typically need to be trained on large, labelled datasets. Training a neural network can take a significant amount of time and consume large amounts of computing resources. Another drawback is that neural networks are sensitive to noise and lighting variation in the 2D images used for training and inferencing operations, which can result in inaccurate segmentations and, ultimately, inaccurate reconstructed 3D maps.

Another approach for improving the accuracy of 3D scene reconstruction involves using range sensors, such as light detection and ranging (LiDAR) scanners, to increase the accuracy of the geometric information used to generate a reconstructed 3D map. A LIDAR scanner emits a laser pulse at an object and measures the amount of time needed for the pulse to return to the scanner. The distance between the object and the scanner can then be computed based on that amount of time. LiDAR scanners can emit thousands of pulses per second, which enable an enhanced understanding of the depths and geometries of different objects within the 3D scene for which the 3D map is being generated. In particular, the information received from LIDAR scanners can be used with SfM to produce a more detailed and accurate reconstruction of the 3D scene. However, LiDAR scanners can be expensive, and the high cost and limited portability can make LiDAR scanners impractical for many applications.

As the foregoing illustrates, what is needed in the art are more effective techniques for reconstructing 3D maps.

### SUMMARY

One embodiment of the present disclosure sets forth a computer-implemented method for generating a 3D environment map. The method comprises receiving a plurality of images from multiple traversals of a scene; generating a plurality of 3D Gaussians from the plurality of images; projecting each of the plurality of 3D Gaussians to generate a plurality of rendered 2D images; extracting a feature map from each of the plurality of images and the plurality of rendered 2D images; generating ephemeral objects masks for the plurality of images from the feature maps and the plurality of rendered 2D images; generating optimized 3D Gaussians from the plurality of images, the plurality of rendered 2D images, and the ephemeral objects masks; and generating a 3D environment from the optimized 3D Gaussians.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, accurate reconstruction of 3D environments with ephemeral objects removed can be generated without having to train specialized neural models, which significantly reduces the computing resources used to generate the reconstructed 3D environment. The disclosed techniques further eliminate the need to generate large labeled datasets to generate the reconstructed 3D environment. In addition, the disclosed techniques reduce the impact of noise or light levels in the images used to generate the reconstructed 3D environment. The disclosed techniques also avoid the need to use expensive ranging sensors to generate the reconstructed 3D environment. These technical advantages represent one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a computer system configured to implement one or more aspects of the present invention;

FIG. 2 is a block diagram of a parallel processing unit included in the parallel processing subsystem of FIG. 1, according to various embodiments of the present invention;

FIG. 3 is a block diagram of a general processing cluster included in the parallel processing unit of FIG. 2, according to various embodiments of the present invention;

FIG. 4 is a block diagram of a computer-based system configured to implement one or more aspects of the various embodiments;

FIG. 5 is a more detailed description of a 3D map reconstruction engine of FIG. 4, according to various embodiments;

FIG. 6 is a more detailed illustration of ephemeral object segmentation engine of FIG. 5, according to various embodiments;

FIG. 7 is a more detailed illustration of 3D Gaussian mapping of FIG. 5, according to various embodiments;

FIG. 8 is a flow diagram of method steps for generating 3D environment maps, according to various embodiments;

FIG. 9 is a flow diagram of method steps for using 3D environment maps, according to various embodiments;

FIG. 10A illustrates exemplary ephemeral objects masks generated by the ephemeral object segmentation engine of FIG. 5, according to various embodiments; and

FIG. 10B illustrates exemplary 3D environment maps generated by the 2D map reconstruction engine of FIG. 5, according to various embodiments.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

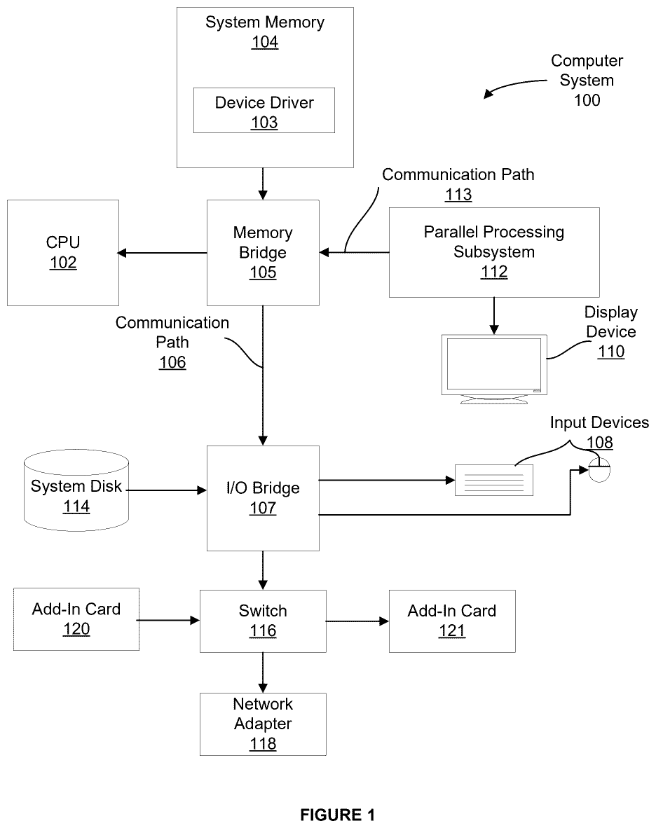

FIG. 1 is a block diagram of a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116. As persons skilled in the art will appreciate, computer system 100 can be any type of technically feasible computer system, including, without limitation, a server machine, a server platform, a desktop machine, laptop machine, or a hand-held/mobile device. Persons skilled in the art also will appreciate that computer system 100 or systems similar to computer system 100 can be incorporated into a vehicle or machine to facilitate driving, steering, or otherwise controlling that vehicle or machine, as the case may be.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbrige chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

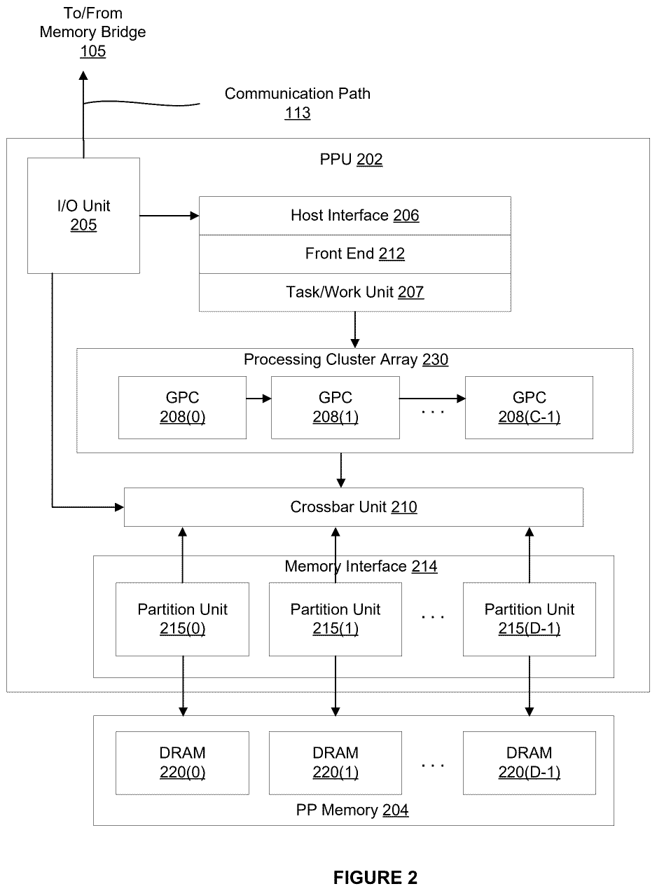

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to various embodiments of the present invention. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C 1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D□1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

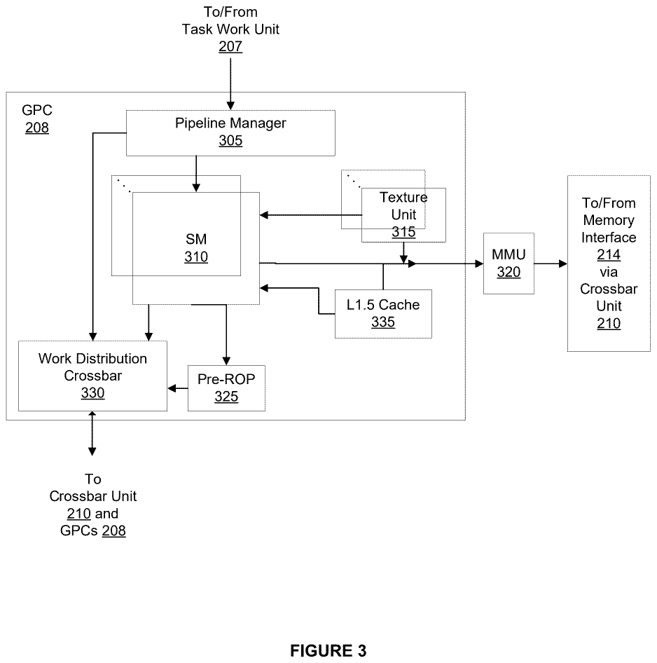

FIG. 3 is a block diagram of a GPC 208 included in PPU 202 of FIG. 2, according to various embodiments of the present invention. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the present invention.

### 3D Environment Map Generation and Use

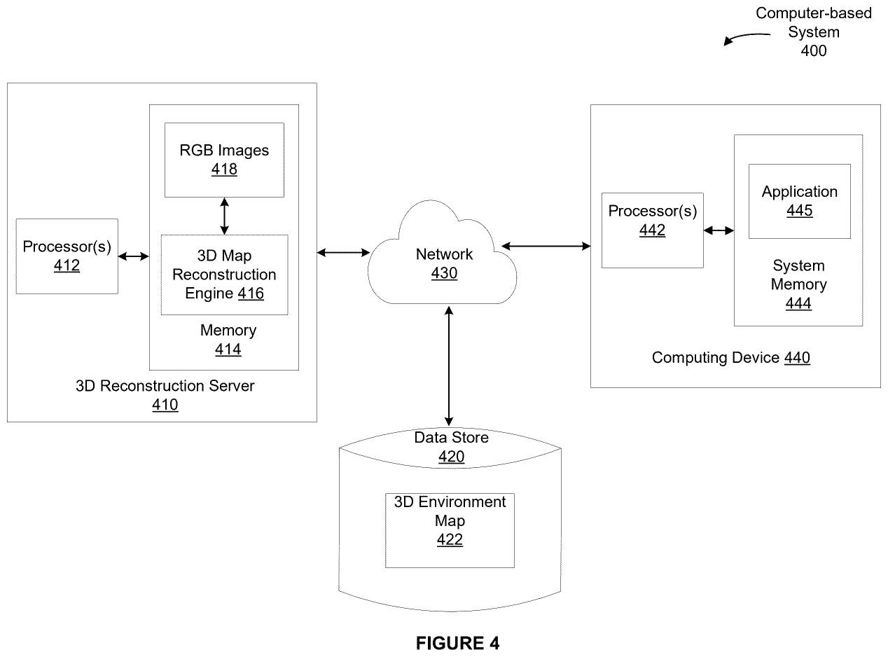

FIG. 4 illustrates a block diagram of a computer-based system 400 configured to implement one or more aspects of the various embodiments. As shown, computer-based system 400 includes, without limitation, a 3D reconstruction server 410, a data store 420, a network 430, and a computing device 440. 3D reconstruction server 410 includes, without limitation, processor(s) 412 and a system memory 414. System memory 414 includes, without limitation, a 3D map reconstruction engine 416 and RGB images 418. Computing device 440 includes, without limitation, processor(s) 442 and memory 444. Memory 444 includes, without limitation, an application 445. Data store 420 stores, without limitation, 3D environment map 422. Each of 3D reconstruction server 410 and computing device 440 can include similar components, features, and/or functionality as the exemplary computer system 100, described above in conjunction with FIG. 1-3. Each of 3D reconstruction server 410 and computing device 440 can be any technically feasible type of computer system, including, without limitation, a server machine or a server platform.

3D reconstruction server 410 shown herein is for illustrative purposes only, and variations and modifications are possible without departing from the scope of the present disclosure. For example, the number and types of processors 412, the number of GPUs and/or other processing unit types, the number and types of system memories 414, and/or the number of applications included in the system memory 414 can be modified as desired. Further, the connection topology between the various units within 3D reconstruction server 410 can be modified as desired. In some embodiments, any combination of the processor(s) 412 and the system memory 414, and/or GPU(s) can be included in and/or replaced with any type of virtual computing system, distributed computing system, and/or cloud computing environment, such as a public, private, or a hybrid cloud system.

Processor(s) 412 receive user input from input devices, such as a keyboard or a mouse. Processor(s) 412 can be any technically feasible form of processing device configured to process data and execute program code. For example, any of processor(s) 412 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 412, or any combination of these different processors, such as a CPU working in cooperation with one or more GPUs. In various embodiments, the processor(s) 412 can issue commands that control the operation of one or more GPUs (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

System memory 414 of 3D reconstruction server 410 stores content, such as software applications and data, for use by processor(s) 412. System memory 414 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace system memory 414. The storage can include any number and type of external memories that are accessible to processor(s) 412. For example, and without limitation, the storage can include a Secure Digital Card, an external Flash memory, a portable compact disc read-only memory (CD-ROM), an optical storage device, a magnetic storage device, and/or any suitable combination of the foregoing.

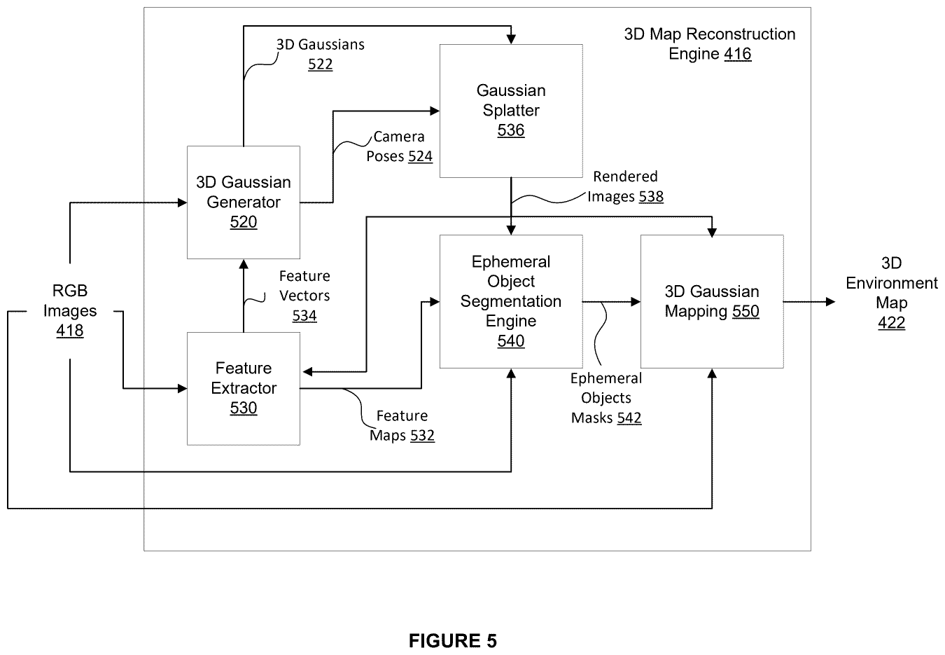

3D map reconstruction engine 416 stored within system memory 414 is configured to generate 3D environment map 422 using RGB images 418 from multiple traversals of the same scene. First, a set of 3D Gaussians is generated from RGB images 418, and a camera pose is generated for each RGB image 418. The 3D Gaussians and the camera poses are then used to generate rendered images using a splatting based rasterization technique. Next, feature maps and feature vectors are extracted from RGB images 418 and the rendered images using a vision transformer. The feature maps for RGB images 418 and the rendered images are then used to generate ephemeral objects masks. The parameters of the 3D Gaussians are optimized and 3D environment map 422 is generated as a 3D reconstruction of RGB images 418 with the ephemeral objects segmented out. 3D map reconstruction engine 416 then stores 3D environment map 422 in data store 420. 3D environment map 422 can then be used in any suitable application, such as application 445 executing on computing device 440. The operations performed by 3D map reconstruction engine 416 to generate 3D environment map 422 are described in greater detail below in conjunction with FIGS. 5-8.

RGB images 418 can be obtained by any type of technically feasible video capture device. For example, and without limitation, RGB images 418 can be obtained by a monocular camera with a resolution of 900×600 pixels, such as a smartphone camera or a camera located in a vehicle. In various embodiments, RGB images 418 can include images from repeated traversals of the same region at different times. During each traversal, RGB images 418 may capture both permanent and ephemeral objects. Ephemeral objects include, without limitation, objects that either appear or disappear over time across different RGB images 418 of the same general location, such as pedestrians, motorbikes, and vehicles. Although not shown in FIG. 4, RGB images 418 can be loaded by 3D map reconstruction engine 416 from data store 420 and/or one or more other data repositories.

Data store 420 provides non-volatile storage for applications and data in 3D reconstruction server 410 and computing device 440. For example, and without limitation, training data, trained (or deployed) machine learning models and/or application data, RGB images 418, and 3D environment map 422 can be stored in the data store 420 for use by application 445. In some embodiments, data store 420 can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 420 can be a network attached storage (NAS) and/or a storage area-network (SAN). Although shown as coupled to 3D reconstruction server 410 and computing device 440 via network 430, in various embodiments, 3D reconstruction server 410 or computing device 440 can include data store 420.

Network 430 includes any technically feasible type of communications network that allows data to be exchanged between 3D reconstruction server 410, computing device 440, data store 420 and external entities or devices, such as a web server or another networked computing device. For example, network 430 can include a wide area network (WAN), a local area network (LAN), a cellular network, a wireless (WiFi) network, and/or the Internet, among others.

Computing device 440 shown herein is for illustrative purposes only, and variations and modifications are possible without departing from the scope of the present disclosure. For example, the number and types of processors 442, the number and types of system memories 444, and/or the number of applications included in the system memory 444 can be modified as desired. Further, the connection topology between the various units within computing device 440 can be modified as desired. In some embodiments, any combination of the processor(s) 442 and/or the system memory 444 can be included in and/or replaced with any type of virtual computing system, distributed computing system, and/or cloud computing environment, such as a public, private, or a hybrid cloud system. In various embodiments, computing device 440 can be implemented using any of the computing devices of FIGS. 1-3.

Similar to processor(s) 412, processor(s) 442 receive user input from input devices, such as a keyboard or a mouse. Processor(s) 442 can be any technically feasible form of processing device configured to process data and execute program code. For example, any of processor(s) 442 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 442, or any combination of these different processors, such as a CPU working in cooperation with a one or more GPUs. In various embodiments, the one or more GPU(s) perform parallel processing task, such as matrix multiplications and/or the like in LLM model computations. Processor(s) 442 can also receive user input from input devices, such as a keyboard or a mouse and generate output on one or more displays.

Similar to memory 414 of 3D reconstruction server 410, system memory 444 of computing device 440 stores content, such as software applications and data, for use by the processor(s) 442. The system memory 444 can be any type of memory capable of storing data and software applications, such as a RAM, ROM, EPROM, Flash ROM, or any suitable combination of the foregoing. In some embodiments, a storage (not shown) can supplement or replace the system memory 444. The storage can include any number and type of external memories that are accessible to processor 442. For example, and without limitation, the storage can include a Secure Digital Card, an external Flash memory, a portable CD-ROM, an optical storage device, a magnetic storage device, and/or any suitable combination of the foregoing.

As shown, memory 444 includes application 445. Application 445 accesses 3D environment map 422 from data store 420. Application 445 can be, without limitation, any type of navigation system, map, or route and direction assistant in an autonomous or manned vehicle and/or a hand-held device. For example, application 445 can load 3D environment map 422 and then use vehicle location and position information and 3D environment map 422 to render an image of the current location. In various embodiments, application 445 shows previews of a planned route, renders a view from specific coordinates, or annotates an image to displays landmarks or other points of interest.

FIG. 5 is a more detailed illustration of 3D map reconstruction engine 416 of FIG. 4, according to various embodiments. As shown, 3D map reconstruction engine 416 includes, without limitation, 3D Gaussian generator 520, 3D Gaussians 522, camera poses 524, feature extractor 530, feature maps 532, feature vectors 534, Gaussian splatter 536, rendered images 538, ephemeral object segmentation engine 540, ephemeral objects masks 542, and 3D Gaussian mapping 550. In operation, 3D map reconstruction engine 416 receives RGB images 418 and generates 3D environment map 422. In various embodiments, RGB images 418 can include images from repeated traversals of the same region at different times.

Feature extractor 530 can be any type of technically feasible self-supervised machine learning model. For example, in various embodiments, feature extractor 530 can be a vision transformer with any suitable architecture. Self-supervised learning is a method of training machine learning models using only the input dataset without the associated labels. In various embodiments, the input dataset to feature extractor 530 is an image or video data, such as RGB images 418 and rendered images 538. More generally, the input dataset to feature extractor 530 can include any technically feasible data that can be processed by a transformer-based model for computer vision. For each input image, feature extractor 530 generates a feature map 532 and a feature vector 534. A feature map 532 includes information on the features across a given image, such as edges and parts of objects within the given image. A feature vector 534 includes information on features from a specific region within the given image.

3D Gaussian generator 520 receives as input RGB images 418 and feature vectors 524 from feature extractor 530. 3D Gaussian generator 520 uses an SfM technique, to generate a camera pose 524 for each RGB image 418 as well as a sparse 3D point cloud. 3D Gaussian generator 520 can use any feasible SfM technique to generate camera poses 524 and a sparse 3D point cloud, including incremental SfM, hierarchical SfM, global SfM, and the like. For each RGB image 418, camera pose 524 includes information on the position and orientation of the camera used to take the image. For each point of the sparse 3D point cloud, 3D Gaussian generator generates a 3D Gaussian centered at that point. The resulting set of 3D Gaussians 522 is denoted as G={G_i|i=1, . . . , N}, where N is the total number of Gaussians. Each 3D Gaussian Gᵢ included in the set of 3D Gaussians 522 is defined by a mean vector μᵢ indicating the position of Gᵢ and a covariance matrix Σᵢ characterizing the shape of Gᵢ. The position μᵢ of each 3D Gaussian Gᵢ is initialized as the position of the corresponding point of the sparse 3D point cloud. Each covariance matrix Σᵢ is initialized to be isotropic, corresponding to a sphere with radius equal to the mean of the distance of the closest three neighboring points. The covariance matrix Σᵢ can be decomposed as Σᵢ=RᵢSᵢRᵢ^{T}, where Rᵢ is an orthogonal rotation matrix and Sᵢ is a diagonal scaling matrix. The information from the matrix Rᵢ can be stored as a rotation quaternion vector qᵢ and the information from the matrix Sᵢ can be stored as a scaling vector sᵢ. Each Gaussian Gᵢ also incorporates a scalar opacity value αᵢ and a spherical harmonics coefficient βᵢ representing the color of each Gᵢ. Then, [μᵢ, qᵢ, sᵢ, αᵢ, βᵢ, fᵢ] form a set of learnable parameters for Gᵢ, where fᵢ is a feature vector 534 received from feature extractor 530. Camera poses 524 and 3D Gaussians 522 can then be used by Gaussian splatter 536 to generate rendered images 538.

Gaussian splatter 536 receives 3D Gaussians 522 and camera poses 524 from 3D Gaussian generator 520. Gaussian splatter 536 uses a splatter-based rasterization technique to generate rendered images 538. Rasterization is a technique that converts a vector-based object into a pixel-based object. Gaussian splatter 536 projects the 3D Gaussians 522 onto a 2D pixel-based image plane. The 3D Gaussians 522 are then sorted and the color of each pixel p, cₚ, is computed according to equation (1):

$${c}_{p} = {\sum }_{k = 1}^{K} {c}_{k} {α}_{k} {\prod }_{j = 1}^{k - 1} ( 1 - {α}_{j} ) \qquad ( 1 )$$

where cₖ is the color obtained by evaluating the spherical harmonics of Gₖ and αⱼ is the final opacity, resulting in rendered images 538. Rendered images 538 are then passed to feature extractor 530 to generate corresponding feature maps 532. Rendered images 538 can be used by ephemeral object segmentation engine 540 to generate ephemeral objects masks 542, and by 3D Gaussian Mapping 550 to generate 3D environmental map 422.

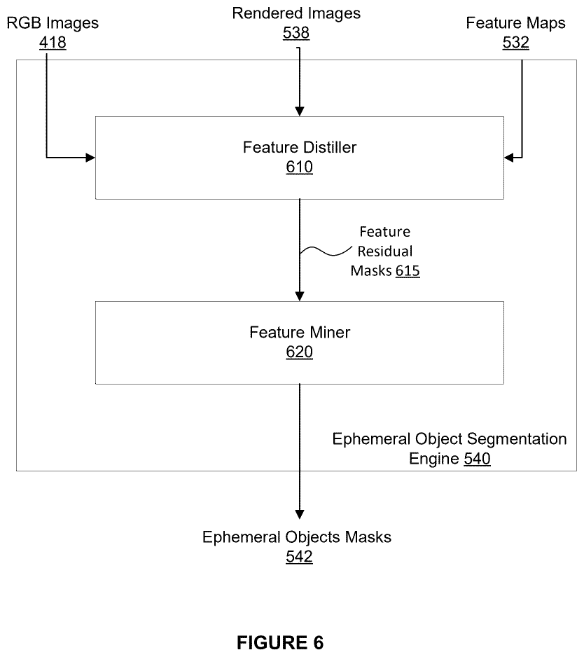

Ephemeral object segmentation engine 540 receives RGB images 418, feature maps 532 from feature extractor 530, and rendered images 538 from Gaussian splatter 536. For each RGB image 418, ephemeral object segmentation engine 540 minimizes the feature rendering loss to obtain feature residual maps. Ephemeral object segmentation engine 540 then uses the spatial information in the feature residual maps to generate the ephemeral objects masks 542. The operations of ephemeral object segmentation engine 540 are described in further detail below in conjunction with FIG. 6.

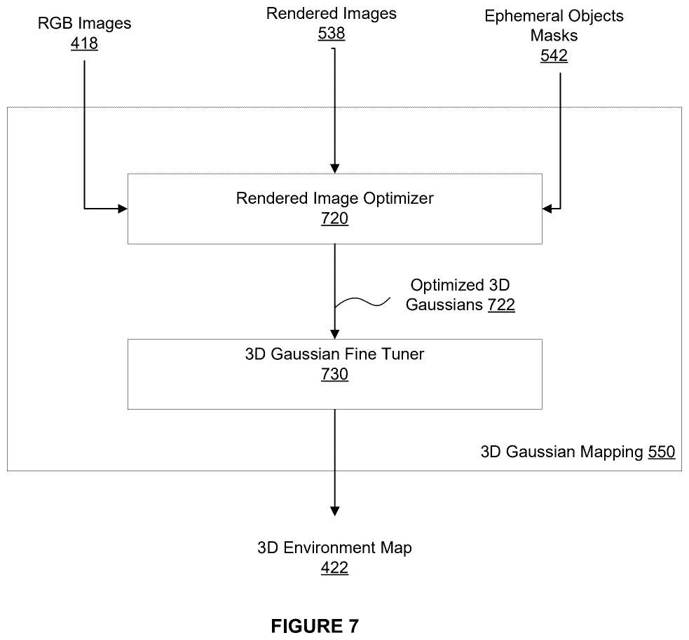

3D Gaussian mapping 550 receives RGB images 418, ephemeral objects masks 542 from ephemeral object segmentation engine 540, and rendered images 538 from Gaussian splatter 536. 3D Gaussian mapping 550 optimizes the parameters of 3D Gaussians 522 by minimizing the loss between the element-wise product of the ephemeral objects masks 542 and the rendered images 538 and the element-wise product of the ephemeral objects masks 542 and the RGB images 418. The resulting optimized 3D Gaussians are then fine-tuned to generate 3D environment map 422. 3D environment map 422 is a reconstructed 3D scene that closely matches RGB images 418, where any ephemeral objects from RBG 418 have been segmented out of the reconstructed 3D scene. The operations of 3D Gaussian mapping 550 are described in further detail below in conjunction with FIG. 7.

FIG. 6 is a more detailed illustration of ephemeral object segmentation engine 540 of FIG. 5, according to various embodiments. As shown, ephemeral object segmentation engine 540 includes, without limitation, feature distiller 610, feature residuals mask 615, and feature miner 620. As noted above, ephemeral object segmentation engine 540 receives RGB images 418, rendered images 538 from Gaussian splatter 536, and feature maps 532 from feature extractor 530 and generates ephemeral objects masks 542. More specifically, RGB images 418, rendered images 538, and feature maps 532 are input into feature distiller 610.

Feature distiller 610 trains the feature residuals map { [symbol] _feat (F_t (ξ_t; G), F_t) |t=1, . . . , T} to learn the permanent features in the feature space by minimizing the loss between each rendered image 538 and the corresponding RGB image 418 and the loss between the feature map for each rendered image 538 and the feature map for the corresponding RGB image 418 in accordance with equation (2):

$$ℒ = {\sum }_{t} {ℒ}_{rgb} ( {I}_{t} ( {ξ}_{t} ; G ) , {I}_{t} ) + {ℒ}_{feat} ( {F}_{t} ( {ξ}_{t} ; G ) , {F}_{t} ) \qquad ( 2 )$$

where Iₜ(ξₜ; G) is the rendered image and Fₜ(ξₜ; G) is the feature map given camera pose ξₜ and Gaussians G, Iₜ is the corresponding RGB image, Fₜ is the feature map for Iₜ, and [symbol] _{rgb} and [symbol] _{feat} are loss functions. Examples of suitable loss functions [symbol] _{rgb} and [symbol] _{feat} include, without limitation, L₁ loss, mean squared error (MSE), and normalized MSE. The trained feature residual masks 615 are then passed to feature miner 620.

Feature miner 620 uses feature residual masks 615 to generate ephemeral objects masks 542. Ephemeral objects masks 542 specify the areas of RGB images 418 that contain ephemeral objects to be segmented out. First, feature residual masks 615 are normalized over all pixels and the pixels with values below a predefined threshold δ are set to zero. Next, feature miner 620 extracts contours from the normalized residual maps. A contour is a curve which joins points having the same color or intensity. The contours are refined to eliminate those that are too small or located in the sky, and nearby contours are merged. Feature miner 620 then extracts a convex hull for each merged contour. The convex hull is the smallest convex polygon that encloses all points of the contour. Ephemeral objects masks 542 are then generated by marking the pixels inside the convex hulls as masked-out regions. After completing these operations, feature miner 620 passes ephemeral objects masks 542 to 3D Gaussian mapping 550.

FIG. 7 is a more detailed illustration of 3D Gaussian mapping 550 of FIG. 5, according to various embodiments. As shown, 3D Gaussian mapping 550 includes, without limitation, rendered image optimizer 720, optimized 3D Gaussians 722, and 3D Gaussian fine tuner 730. As noted above, in operation, 3D Gaussian mapping 550 receives RGB images 418, rendered images 538 from Gaussian splatter 536, and ephemeral objects masks 542 from ephemeral object segmentation engine 540 and generates 3D environment map 422. More specifically, RGB images 418, rendered images 538 from Gaussian splatter 536, and ephemeral objects masks 542 from ephemeral object segmentation engine 540 are input into rendered image optimizer 720.

Rendered image optimizer 720 trains each rendered image 538 to closely match the corresponding original RGB image 418. Rendered image optimizer 720 can use any feasible training technique to train rendered images 538, such as stochastic gradient descent. During training, rendered image optimizer 720 minimizes the loss between the element-wise product of ephemeral objects masks 542 and rendered images 538 and the element-wise product of ephemeral objects masks 542 and the corresponding RGB images 418 according to equation (3):

$$ℒ = {\sum }_{t} {ℒ}_{rgb} ( {M}_{t ⊙ {I}_{t} ( {ξ}_{t} ; G )} , {M}_{t ⊙ {I}_{t}} ) \qquad ( 3 )$$

where Iₜ(ξₜ; G) is the rendered image given camera pose ξₜ and Gaussians G, Iₜ is the corresponding RGB image, Mₜ is the corresponding ephemeral objects mask, and [symbol] _{rgb} is a loss function. Examples of suitable loss functions [symbol] _{rgb} include, without limitation, L₁ loss, inverse depth smoothness loss, and sky loss.

Rendered image optimizer 720 then updates the parameters [μᵢ, qᵢ, sᵢ, αᵢ, βᵢ, fᵢ] associated with each Gaussian Gᵢ, according to the training technique to obtain a set of optimized 3D Gaussians 722. Rendered image optimizer 720 passes optimized 3D Gaussians 722 to 3D Gaussian fine tuner 730 to improve the quality of the 3D scene reconstruction. For each optimized 3D Gaussian, 3D Gaussian fine tuner 730 determines if the optimized 3D Gaussian should be removed or densified. For example, and without limitation, 3D Gaussian fine tuner removes optimized 3D Gaussians 722 with an opacity value at below a given threshold. In various embodiments, 3D Gaussian fine tuner 730 also densifies optimized 3D Gaussians 722. For example, and without limitation, 3D Gaussian fine tuner 730 clones a small optimized 3D Gaussian 722 in an under-constructed region and splits a large optimized 3D Gaussian 722 into smaller optimized 3D Gaussians 722. After fine-tuning, 3D Gaussian fine tuner 730 outputs 3D environment map 422 that closely matches RGB images 418, where any ephemeral objects from RBG 418 have been segmented out of the reconstructed 3D scene.

### Generating 3D Environment Maps

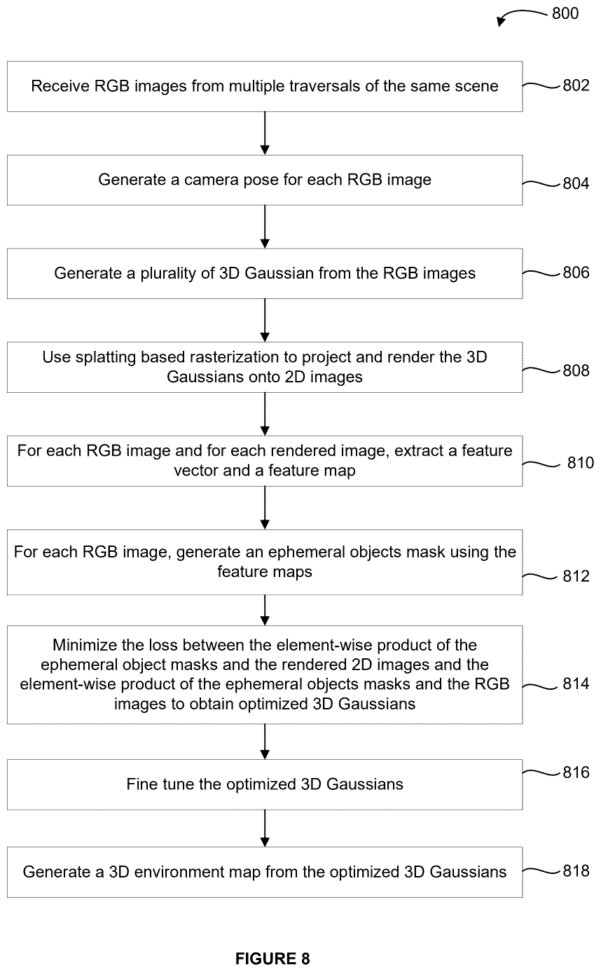

FIG. 8 is a flow diagram of method steps for generating 3D environment maps, according to various embodiments. Although the method steps are described in conjunction with the systems of FIGS. 1-7, persons skilled in the art will understand that any system configured to perform the method steps, in any order, falls within the scope of the various embodiments.

As shown, a method 800 begins at step 802, where 3D map reconstruction engine 416 receives RGB images 418 from multiple traversals of the same scene. During each traversal of the same scene, RGB images 418 typically capture both permanent and ephemeral objects. RGB images 418 can be obtained by any type of technically feasible video capture device. For example, and without limitation, RGB images 418 can be obtained by a monocular camera with a resolution of 900×600 pixels, such as a smartphone camera or a camera located in a vehicle.

At step 804, 3D map reconstruction engine 416 generates a camera pose 524 for each RGB image 418. More specifically, 3D Gaussian generator 520 uses an SfM technique, to generate a camera pose 524 for each RGB image 418. 3D Gaussian generator 520 can use any feasible SfM technique to generate camera poses 524 including incremental SfM, hierarchical SfM, global SfM, and the like. For each RGB image 418, camera pose 524 includes information on the position and orientation of the camera used to take the image.

At step 806, 3D map reconstruction engine 416 generates a plurality of 3D Gaussians 522 from RGB images 418. More specifically, 3D Gaussian generator 520 generates a sparse 3D point cloud using an SfM technique. For each point of the sparse 3D point cloud, 3D Gaussian generator 520 generates a 3D Gaussian 522 centered at that point. Each 3D Gaussian 522 is characterized by a set of learnable parameters that include information on the position, rotation, opacity, color, etc. of each 3D Gaussian.

At step 808, Gaussian splatter 536 uses a splatter-based rasterization technique to project and render 3D Gaussians 522 onto 2D images to generate rendered images 538. First, Gaussian splatter 536 projects the 3D Gaussians 522 onto a 2D pixel-based image plane. Gaussian splatter 536 then uses equation (1) to compute the color of each pixel of the 2D image plane, resulting in rendered images 538.

At step 810, for each RGB image 418 and for each rendered image 538, feature extractor 530 extracts a feature vector 534 and a feature map 532. Feature extractor 530 can be any type of technically feasible self-supervised machine learning model. For example, in various embodiments, feature extractor 530 can be a vision transformer with any suitable architecture. For each input image, feature extractor 530 generates a feature map 532 and a feature vector 534. A feature map 532 includes information on the features across a given image, such as edges and parts of objects within the given image. A feature vector 534 includes information on features from a specific region within the given image.

At step 812, for each RGB image 418, ephemeral object segmentation engine 540 generates an ephemeral objects mask 542 using feature maps 532. More specifically, feature distiller 610 trains the feature residuals maps to learn the permanent features in the feature space by minimizing the loss between each rendered image 538 and the corresponding RGB image 418 and the loss between the feature map for each rendered image 538 and the feature map for the corresponding RGB image 418 as indicated by equation (2). Examples of suitable loss functions for [symbol] _{rgb} and [symbol] _{feat} in equation (2) include, without limitation, L₁ loss, mean squared error (MSE), and normalized MSE. Feature miner 620 then extracts a convex hull for each merged contour from the normalized feature residual maps and generates ephemeral objects masks 542 by marking the pixels inside the convex hulls as masked-out regions.

At step 814, rendered image optimizer 720 minimizes the loss between the element-wise product of ephemeral objects masks 542 and rendered images 538 and the element-wise product of ephemeral objects masks 542 and the corresponding RGB images 418 to obtain optimized 3D Gaussians 722. Rendered image optimizer 720 uses equation (3) to train each rendered image 538 to closely match the corresponding original RGB image 418. Rendered image optimizer 720 can use any feasible training technique to train rendered images 538, such as stochastic gradient descent. Rendered image optimizer 720 then updates the parameters [μᵢ, qᵢ, sᵢ, αᵢ, βᵢ, fᵢ] associated with each Gaussian Gᵢ, according to the training technique to obtain a set of optimized 3D Gaussians 722.

At step 816, 3D Gaussian fine tuner 730 fine tunes optimized 3D Gaussians 722 to improve the quality of the 3D scene reconstruction. For each optimized 3D Gaussian, 3D Gaussian fine tuner 730 determines if the optimized 3D Gaussian should be removed or densified. For example, and without limitation, 3D Gaussian fine tuner removes optimized 3D Gaussians 722 with an opacity value αᵢ below a given threshold. In various embodiments, 3D Gaussian fine tuner 730 also densifies optimized 3D Gaussians 722. For example, and without limitation, 3D Gaussian fine tuner 730 clones a small optimized 3D Gaussian 722 in an under-constructed region and splits a large optimized 3D Gaussian 722 into smaller optimized 3D Gaussians 722.

At step 818, 3D Gaussian fine tuner 730 generates 3D environment map 422 from the optimized 3D Gaussians 722. 3D Gaussian fine tuner 730 generates 3D environment map 422 from the optimized 3D Gaussians 722 to best match RGB images 418 for the 3D environment. The generated 3D environment map 422 includes the content of RGB images that correspond to permanent objects and removes the ephemeral objects.

### Using 3D Environment Maps

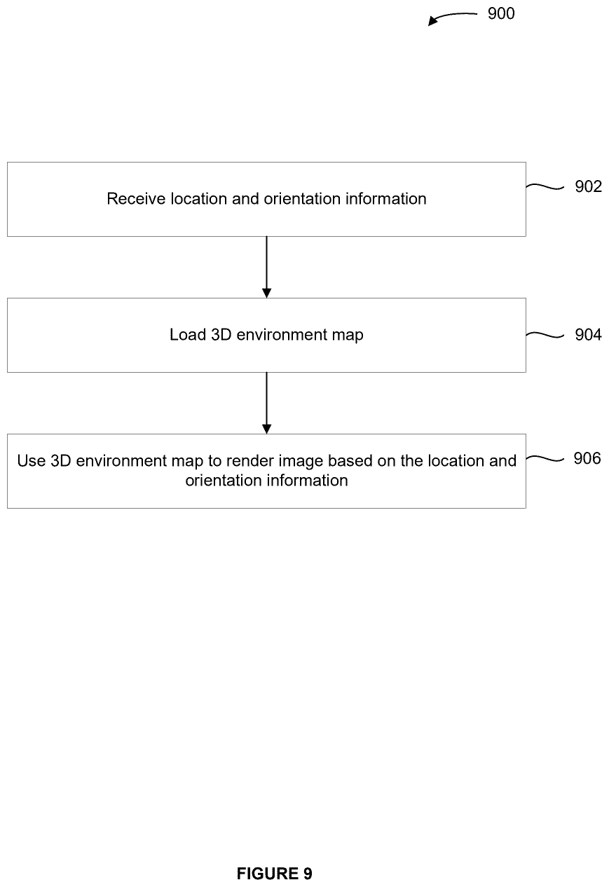

FIG. 9 is a flow diagram of method steps for using 3D environment maps, according to various embodiments. Although the method steps are described in conjunction with the systems of FIGS. 1-7, persons skilled in the art will understand that any system configured to perform the method steps, in any order, falls within the scope of the various embodiments.

As shown, a method 900 begins at step 902, where application 445 receives location and orientation information. The location and orientation information can include a position of a device on which application 445 is executing, an orientation of the device, and/or a direction of travel for the device. For example, when the device is located in a vehicle, the location and orientation information can indicate where the vehicle is located and an orientation direction of the vehicle. Application 445 can be, without limitation, any type of navigation system, map, or route and direction assistant in an autonomous or manned vehicle or a hand-held device.

At step 904, application 445 loads 3D environment map 422. For example, application 445 can load 3D environment map 422 from data store 420. 3D environment map 422 can include any 3D environment map 422, such a 3D environment map 422 generated using method 800.

At step 906, application 445 uses 3D environment map 422 to render an image based on the location and orientation information. In various embodiments, application 445 uses the location and orientation of the device in which application 445 is executing to determine a corresponding viewing perspective in 3D environment map 422. Application 445 then uses the corresponding viewing perspective to render a view of the 3D environment captured by 3D environment map 422. The view can assist a user during navigation by showing images of the 3D environment. Additionally or alternatively, the images can be further annotated to identify landmarks or other points of interest.

### Examples of Ephemeral Objects masks and 3D Environment Maps

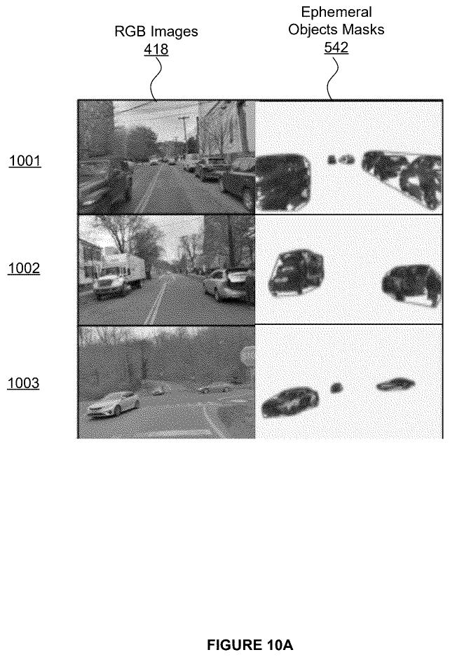

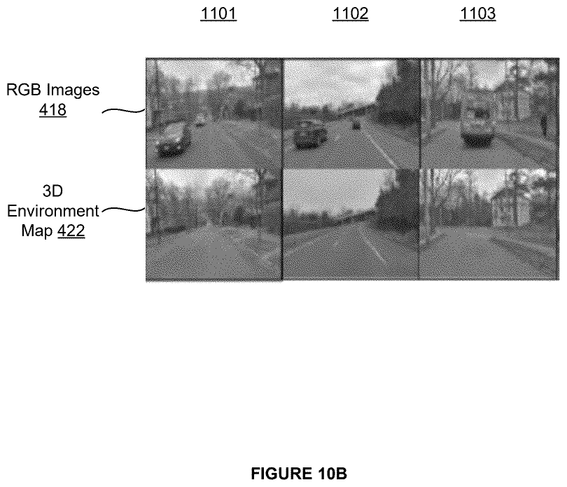

FIG. 10A illustrates different exemplary ephemeral objects masks 542 generated by ephemeral object segmentation engine 540 that can be used to construct 3D environment map 422, according to various embodiments. FIG. 10A includes examples 1001, 1002, and 1003. Each example 1001, 1002, and 1003 includes an RGB image 418 of a different scene and the corresponding ephemeral objects masks 542. As described above in conjunction with FIG. 6, ephemeral objects masks 542 are generated by ephemeral object segmentation engine 540 and specify the areas of RGB images 418 that contain ephemeral objects to be segmented out. More specifically, feature miner 620 extracts contours from the normalized residual maps and generates ephemeral objects masks 542 by marking the pixels inside the convex hulls of the contours as masked-out regions. In example 1001, the parked vehicles on the right and the vehicles driving down the street on the left in RGB image 418 are identified as ephemeral objects by ephemeral object segmentation engine 540 as shown in the corresponding ephemeral objects mask 542. The buildings, trees, utility poles, pavement, and road lines in RGB image 418 of example 1001 are not identified as ephemeral objects. In example 1002, the parked truck on the left and the parked vehicle and pedestrian on the right in RGB image 418 are identified as ephemeral objects by ephemeral object segmentation engine 540 as shown in the corresponding ephemeral objects mask 542. The buildings, trees, utility poles, pavement, and road lines in RGB image 418 of example 1002 are not identified as ephemeral objects. In example 1003, the vehicles in RGB image 418 are identified as ephemeral objects by ephemeral object segmentation engine 540 as shown in the corresponding ephemeral objects mask 542. The trees, pavement, road lines, and the stop sign in RGB image 418 of example 1002 are not identified as ephemeral objects.

FIG. 10B illustrates an RGB image 418 of a scene and the corresponding 3D environment map 422 generated by 3D map reconstruction engine 416. FIG. 10B includes examples 1101, 1102, and 1103. Each example 1101, 1102, and 1103 includes an RGB image 418 of a different scene and the corresponding 3D environment map 422. As described above in conjunction with FIG. 7, rendered image optimizer 720 minimizes the loss between the element-wise product of ephemeral objects masks 542 and rendered images 538 and the element-wise product of ephemeral objects masks 542 and the corresponding RGB images 418. The resulting optimized 3D Gaussians are fine-tuned to generate 3D environment map 422, which is a reconstructed 3D scene that closely matches the originally collected RGB images 418 with the ephemeral objects removed. In example 1101, 3D environment map 422 is the reconstruction of the non-ephemeral objects of RGB image 418, including the buildings, trees, and pavement. The ephemeral objects of the corresponding RGB image 418, including vehicles, are not included in 3D environment map 422. In example 1102, 3D environment map 422 is the reconstruction of the non-ephemeral objects of the corresponding RGB image 418, including the trees, pavement, road lines, and road signs. The vehicles driving down the road in RGB 418 are ephemeral objects and are not included in 3D environment map 422. In example 1103, 3D environment map 422 is the reconstruction of the non-ephemeral objects of the corresponding RGB image 418, including the trees, building, pavement, and sidewalk. The bus and pedestrian in RGB image 418 are ephemeral objects and are not included in the corresponding 3D environment map 422.

In sum, a 3D map of a 3D scene is reconstructed using a set of 2D images collected from multiple traversals of that same 3D scene. First, each 2D image is represented as a sparse set of 3D Gaussians with learnable parameters, and the camera pose for each 2D image is determined. Next, a vision transformer is used to extract feature maps from each 2D image. The feature maps and camera poses are subsequently used to generate ephemeral objects masks associated with the 3D scene. Ephemeral objects masks indicate the regions of the 2D images that include ephemeral objects that need to be segmented. The 3D Gaussians are projected and rendered onto 2D images using a splatting based rasterization technique. Then, for each given 2D image, the parameters of the 3D Gaussians are learned by minimizing the loss between the element-wise product of the ephemeral objects masks and the rendered 2D images and the element-wise product of the ephemeral objects masks and the ground truth 2D image associated with the given 2D image. The resulting 3D Gaussians are then fine-tuned to reconstruct a 3D scene that closely matches the originally collected 2D images, where any ephemeral objects have been segmented out of the reconstructed 3D scene.

At least one technical advantage of the disclosed techniques relative to the prior art is that, with the disclosed techniques, accurate reconstruction of 3D environments with ephemeral objects removed can be generated without having to train specialized neural models, which significantly reduces the computing resources used to generate the reconstructed 3D environment. The disclosed techniques further eliminate the need to generate large labeled datasets to generate the reconstructed 3D environment. In addition, the disclosed techniques reduce the impact of noise or light levels in the images used to generate the reconstructed 3D environment. The disclosed techniques also avoid the need to use expensive ranging sensors to generate the reconstructed 3D environment. These technical advantages represent one or more technological improvements over prior art approaches.
1. In some embodiments, a computer-implemented method for generating a 3D environment map comprises receiving a plurality of images from multiple traversals of a scene, generating a plurality of 3D Gaussians from the plurality of images, projecting each of the plurality of 3D Gaussians to generate a plurality of rendered 2D images, extracting a feature map from each of the plurality of images and the plurality of rendered 2D images, generating ephemeral objects masks for the plurality of images from the feature maps and the plurality of rendered 2D images, generating optimized 3D Gaussians from the plurality of images, the plurality of rendered 2D images, and the ephemeral objects masks, and generating a 3D environment from the optimized 3D Gaussians.
2. The computer-implemented method of clause 1, wherein the 3D environment has ephemeral objects removed.
3. The computer-implemented method of clauses 1 or 2, wherein each of the ephemeral objects is not present in all of the plurality of images.
4. The computer-implemented method of any of clauses 1-3, wherein each of the plurality of 3D Gaussians corresponds to a point in a sparse 3D point cloud.
5. The computer-implemented method of any of clauses 1-4, wherein each of the 3D Gaussians is centered at a corresponding point in the sparse 3D point cloud and has a covariance matrix based on a sphere having a radius determined from distances to neighboring points in the sparse 3D point cloud.
6. The computer-implemented method of any of clauses 1-5, wherein projecting each of the plurality of 3D Gaussians to generate the plurality of rendered 2D images comprises projecting each of the plurality of 3D Gaussians onto a pixel-based image plane using Gaussian splatter.
7. The computer-implemented method of any of clauses 1-6, wherein a color of each pixel on the pixel-based image plane is determined from spherical harmonics of the plurality of 3D Gaussians.
8. The computer-implemented method of any of clauses 1-7, wherein generating the ephemeral objects masks comprises minimizing a loss between a first rendered 2D image of the plurality of rendered 2D images and a corresponding second image of the plurality of images and a loss between a feature map of the first rendered 2D image and a feature map of the corresponding second image to generate a feature residual map, and generating a contour of an ephemeral object in the corresponding second image based on the feature residual map.
9. The computer-implemented method of any of clauses 1-8, further comprising generating a convex hull from the contour.
10. The computer-implemented method of any of clauses 1-9, wherein generating the optimized 3D Gaussians comprises minimizing a loss between an element-wise product of the ephemeral objects masks and the plurality of rendered 2D images and an element-wise product of the ephemeral objects masks and corresponding images of the plurality of images.
11. The computer-implemented method of any of clauses 1-10, wherein generating the optimized 3D Gaussians further comprises fine tuning the optimized 3D Gaussians by performing one or more of removing optimized 3D Gaussians having an opacity value below a threshold, splitting a first optimized 3D Gaussian into smaller optimized 3D Gaussians, or cloning a first optimized 3D Gaussian to generate a second optimized 3D Gaussian.
12. The computer-implemented method of any of clauses 1-11, further comprising generating a camera pose for each of the plurality of images.
13. In some embodiments, one or more non-transitory computer-readable media store instructions that, when executed by at least one processor, cause the at least one processor to perform the steps of receiving a plurality of images from multiple traversals of a scene, generating a plurality of 3D Gaussians from the plurality of images, projecting each of the plurality of 3D Gaussians to generate a plurality of rendered 2D images, extracting a feature map from each of the plurality of images and the plurality of rendered 2D images, generating ephemeral objects masks for the plurality of images from the feature maps and the plurality of rendered 2D images, generating optimized 3D Gaussians from the plurality of images, the plurality of rendered 2D images, and the ephemeral objects masks, and generating a 3D environment from the optimized 3D Gaussians.
14. The one or more non-transitory computer-readable media of clause 13, wherein each of the plurality of 3D Gaussians corresponds to a point in a sparse 3D point cloud.
15. The one or more non-transitory computer-readable media of clauses 13 or 14, wherein each of the 3D Gaussians is centered at a corresponding point in the sparse 3D point cloud and has a covariance matrix based on a sphere having a radius determined from distances to neighboring points in the sparse 3D point cloud.
16. The one or more non-transitory computer-readable media of any of clauses 13-15, wherein projecting each of the plurality of 3D Gaussians to generate the plurality of rendered 2D images comprises projecting each of the plurality of 3D Gaussians onto a pixel-based image plane using Gaussian splatter.
17. The one or more non-transitory computer-readable media of any of clauses 13-16, wherein generating the ephemeral objects masks comprises minimizing a loss between a first rendered 2D image of the plurality of rendered 2D images and a corresponding second image of the plurality of images and a loss between a feature map of the first rendered 2D image and a feature map of the corresponding second image to generate a feature residual map, and generating a contour of an ephemeral object in the corresponding second image based on the feature residual map.
18. The one or more non-transitory computer-readable media of any of clauses 13-17, wherein generating the optimized 3D Gaussians comprises minimizing a loss between an element-wise product of the ephemeral objects masks and the plurality of rendered 2D images and an element-wise product of the ephemeral objects masks and corresponding images of the plurality of images.
19. The one or more non-transitory computer-readable media of any of clauses 13-18, wherein generating the optimized 3D Gaussians further comprises fine tuning the optimized 3D Gaussians by performing one or more of removing optimized 3D Gaussians having an opacity value below a threshold, splitting a first optimized 3D Gaussian into smaller optimized 3D Gaussians, or cloning a first optimized 3D Gaussian to generate a second optimized 3D Gaussian.
20. In some embodiments, a system comprises one or more memories storing instructions, and one or more processors that are coupled to the one or more memories and, when executing the instructions, are configured to receiving a plurality of images from multiple traversals of a scene, generating a plurality of 3D Gaussians from the plurality of images, projecting each of the plurality of 3D Gaussians to generate a plurality of rendered 2D images, extracting a feature map from each of the plurality of images and the plurality of rendered 2D images, generating ephemeral objects masks for the plurality of images from the feature maps and the plurality of rendered 2D images, generating optimized 3D Gaussians from the plurality of images, the plurality of rendered 2D images, and the ephemeral objects masks, and generating a 3D environment from the optimized 3D Gaussians.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. Iₜ will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a 3D environment map, the method comprising:
receiving a plurality of images from multiple traversals of a scene;
generating a plurality of 3D Gaussians from the plurality of images;
projecting each of the plurality of 3D Gaussians to generate a plurality of rendered 2D images;
extracting a feature map from each of the plurality of images and the plurality of rendered 2D images;
generating ephemeral objects masks for the plurality of images from the feature maps and the plurality of rendered 2D images;
generating optimized 3D Gaussians from the plurality of images, the plurality of rendered 2D images, and the ephemeral objects masks; and
generating a 3D environment from the optimized 3D Gaussians.

2. The computer-implemented method of claim 1, wherein the 3D environment has ephemeral objects removed.

3. The computer-implemented method of claim 2, wherein each of the ephemeral objects is not present in all of the plurality of images.

4. The computer-implemented method of claim 1, wherein each of the plurality of 3D Gaussians corresponds to a point in a sparse 3D point cloud.

5. The computer-implemented method of claim 4, wherein each of the 3D Gaussians is centered at a corresponding point in the sparse 3D point cloud and has a covariance matrix based on a sphere having a radius determined from distances to neighboring points in the sparse 3D point cloud.

6. The computer-implemented method of claim 1, wherein projecting each of the plurality of 3D Gaussians to generate the plurality of rendered 2D images comprises projecting each of the plurality of 3D Gaussians onto a pixel-based image plane using Gaussian splatter.

7. The computer-implemented method of claim 6, wherein a color of each pixel on the pixel-based image plane is determined from spherical harmonics of the plurality of 3D Gaussians.

8. The computer-implemented method of claim 1, wherein generating the ephemeral objects masks comprises:
minimizing a loss between a first rendered 2D image of the plurality of rendered 2D images and a corresponding second image of the plurality of images and a loss between a feature map of the first rendered 2D image and a feature map of the corresponding second image to generate a feature residual map; and
generating a contour of an ephemeral object in the corresponding second image based on the feature residual map.

9. The computer-implemented method of claim 8, further comprising generating a convex hull from the contour.

10. The computer-implemented method of claim 1, wherein generating the optimized 3D Gaussians comprises minimizing a loss between an element-wise product of the ephemeral objects masks and the plurality of rendered 2D images and an element-wise product of the ephemeral objects masks and corresponding images of the plurality of images.

11. The computer-implemented method of claim 10, wherein generating the optimized 3D Gaussians further comprises fine tuning the optimized 3D Gaussians by performing one or more of:
removing optimized 3D Gaussians having an opacity value below a threshold;
splitting a first optimized 3D Gaussian into smaller optimized 3D Gaussians; or
cloning a first optimized 3D Gaussian to generate a second optimized 3D Gaussian.

12. The computer-implemented method of claim 1, further comprising generating a camera pose for each of the plurality of images.

13. One or more non-transitory computer-readable media storing instructions that, when executed by at least one processor, cause the at least one processor to perform the steps of:
receiving a plurality of images from multiple traversals of a scene;
generating a plurality of 3D Gaussians from the plurality of images;
projecting each of the plurality of 3D Gaussians to generate a plurality of rendered 2D images;
extracting a feature map from each of the plurality of images and the plurality of rendered 2D images;
generating ephemeral objects masks for the plurality of images from the feature maps and the plurality of rendered 2D images;
generating optimized 3D Gaussians from the plurality of images, the plurality of rendered 2D images, and the ephemeral objects masks; and
generating a 3D environment from the optimized 3D Gaussians.

14. The one or more non-transitory computer-readable media of claim 13, wherein each of the plurality of 3D Gaussians corresponds to a point in a sparse 3D point cloud.

15. The one or more non-transitory computer-readable media of claim 14, wherein each of the 3D Gaussians is centered at a corresponding point in the sparse 3D point cloud and has a covariance matrix based on a sphere having a radius determined from distances to neighboring points in the sparse 3D point cloud.

16. The one or more non-transitory computer-readable media of claim 13, wherein projecting each of the plurality of 3D Gaussians to generate the plurality of rendered 2D images comprises projecting each of the plurality of 3D Gaussians onto a pixel-based image plane using Gaussian splatter.

17. The one or more non-transitory computer-readable media of claim 13, wherein generating the ephemeral objects masks comprises:
minimizing a loss between a first rendered 2D image of the plurality of rendered 2D images and a corresponding second image of the plurality of images and a loss between a feature map of the first rendered 2D image and a feature map of the corresponding second image to generate a feature residual map; and
generating a contour of an ephemeral object in the corresponding second image based on the feature residual map.

18. The one or more non-transitory computer-readable media of claim 13, wherein generating the optimized 3D Gaussians comprises minimizing a loss between an element-wise product of the ephemeral objects masks and the plurality of rendered 2D images and an element-wise product of the ephemeral objects masks and corresponding images of the plurality of images.

19. The one or more non-transitory computer-readable media of claim 13, wherein generating the optimized 3D Gaussians further comprises fine tuning the optimized 3D Gaussians by performing one or more of:
removing optimized 3D Gaussians having an opacity value below a threshold;
splitting a first optimized 3D Gaussian into smaller optimized 3D Gaussians; or
cloning a first optimized 3D Gaussian to generate a second optimized 3D Gaussian.

20. A system, comprising:
one or more memories storing instructions; and
one or more processors that are coupled to the one or more memories and, when executing the instructions, are configured to:
receiving a plurality of images from multiple traversals of a scene;
generating a plurality of 3D Gaussians from the plurality of images;
projecting each of the plurality of 3D Gaussians to generate a plurality of rendered 2D images;
extracting a feature map from each of the plurality of images and the plurality of rendered 2D images;
generating ephemeral objects masks for the plurality of images from the feature maps and the plurality of rendered 2D images;
generating optimized 3D Gaussians from the plurality of images, the plurality of rendered 2D images, and the ephemeral objects masks; and
generating a 3D environment from the optimized 3D Gaussians.
